(19) United States
(12) Patent Application Publication
(10) Pub. No.: US 2005/0229209 A1
(43) Pub. Date: Oct. 13, 2005

(54) Method and system for providing a video infomercial programming channel

(76) Inventors: William Hazen Hildebolt, New York, NY (US); Daphne Kwon Hildebolt, New York, NY (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 10/821,577

(22) Filed: Apr. 8, 2004

(51) Int. Cl. H04N 7/16; H04N 7/025; H04H 9/00; H04N 7/173; H04N 5/445

(52) U.S. Cl. 725/42; 725/32; 725/112; 725/113; 715/500.1; 715/501.1

(57) ABSTRACT

A method is described including the steps of collecting from third parties prerecorded video advertising segments directed to products and/or services for sale to consumers; overlaying additional information related to the products or services onto the video advertising; introducing the resulting video advertising with overlays into infomercial programming to substantially fill a programming day; committing the programming to a schedule; providing the programming schedule to a programming guide service to include entries of the schedule into the guide for the consumers; and distributing the programming.

### FIELD OF THE INVENTION

The present invention relates generally to the distribution of prerecorded video advertising and, more particularly, the distribution of such advertising through a dedicated programming channel.

### BACKGROUND OF THE INVENTION

Today, local and cable television network programming includes live events, news and entertainment segments, but not pre-recorded, commercial, Long Form Direct Response (“LFDR”) segments or “infomercials”. Although LFDR segments appear on local and cable network television channels, the segments appear during “off-air” periods, where the off-air time has been sold to unaffiliated marketing companies. To the extent that these networks disclaim any association with the segments each half hour while LFDR segments are being aired, it can be said that the networks have completely disassociated themselves from the resulting programming. Because LFDR segments appear during “off-air” time, information about the segments does not appear in network program schedules.

“Off-air” network time is typically sold to the highest bidder. This often creates adjacent time slots of incongruous products. The lack of any type of cognitive effort in addressing this issue leads one to conclude that consumers buying diverse products are channel surfers that just randomly happen upon the infomercials. Attempts by the networks to address this issue are blunted by the fact that industry standards permit cable and satellite providers to override much of the cable networks' paid programming with their own paid programming feed.

Typically, LFDR segments are not listed in any type of electronic or print programming guides. The off-air time is usually identified simply as “paid programming.” Although certain infomercial broadcasters have made electronic programming information available on the Internet, the information does not make its way into television programming guides and the networks that run such infomercials have not branded them or otherwise identified them by any trademark. There are several reasons for the networks not associating themselves with this paid programming. The networks do not want Nielsen™ ratings taken during these time slots to be attributed to them as it would be misleading and could be contrary to their interests. Furthermore, networks do not want such associations as it would lead to brand and viewer confusion between their regularly scheduled programming and paid programming blocks. Finally, because of the relatively short time frames for scheduling paid programming blocks and the extra separation between the various listing agents and the media buyer as well as the risk of network overrides, it would not be feasible to implement listings in programming guides even if all of the parties to network/infomercial agreements were amenable to such listings.

Although products sold by LFDR may be simultaneously promoted by short form commercials, usually 30, 60, 90 and 120 seconds, which promote consumer call-in via 800 numbers, it is difficult for short form advertisements to direct consumer attention to the long form content given the issues noted above.

Currently producers of infomercials produce different versions of shows to test consumer responses to different sales offers or other factors, but these versions are not dependent on the channel where the infomercial runs. Typically such paid programming opens with a black screen and disclaimer language. Virtually all LFDR programming is produced in 28½ minute blocks featuring a single product to fit within conventional half hour broadcasting periods.

There is a need for advertisers to reach consumers using alternate methods that overcome the problems associated with currently produced paid programming.

### SUMMARY OF THE INVENTION

Preferred embodiments of the present invention are directed to methods and systems for providing a video infomercial programming channel.

One embodiment of the method of the present invention includes the steps of collecting from third parties prerecorded video advertising directed to products and/or services for sale to consumers; overlaying additional information onto the video advertising; introducing the resulting video advertising with overlays into infomercial programming to substantially fill an entire day of programming; committing the programming to a schedule; providing the programming schedule to a programming guide service to include entries of the schedule into the guide for the consumers; and distributing the programming to media outlets. These outlets may provide the programming via local, cable, satellite or Internet broadcast, and may provide the programming via a service such as video-on-demand (VOD).

One embodiment of a system for carrying out the method of the present invention includes a first computing system for receiving a plurality of digitized prerecorded video advertising segments from third parties and storing them in a database; a video editor for overlaying or otherwise superimposing additional information specifically related to the product or services onto each of the video advertising segments; a video assembler for identifying and cataloging each of the resulting video advertising segments, assembling each of the segments into infomercial programming in a fixed temporal schedule to substantially fill an entire day of the programming channel, and storing the identification information and programming schedule into the database; and a communication device, e.g. a modem, which is capable of transmitting the identification information and programming schedule to a programming guide service and distributing the programming to media outlets.

### BRIEF DESCRIPTION OF THE DRAWINGS

FIG. 1 is a block diagram of one embodiment of the method of the present invention.

FIG. 2 is a block diagram of one embodiment of the system of the present invention system.

FIGS. 3-11 are screen shots in accordance with a VOD embodiment of the present invention.

### DETAILED DESCRIPTION OF PREFERRED EMBODIMENTS OF THE PRESENT INVENTION

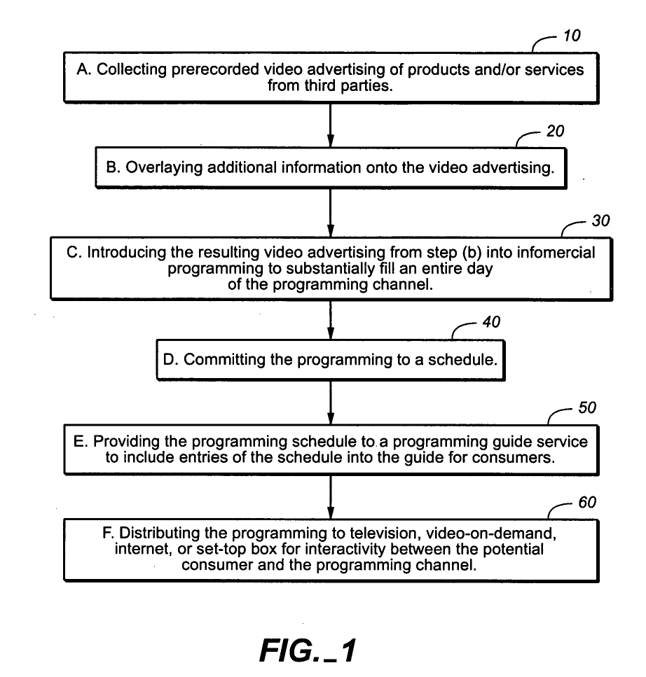

FIG. 1 illustrates a preferred embodiment of the method of the present invention. At step 10, a plurality of prerecorded LFDR videos is collected from one or more advertisers. The videos can be recorded in any format, including analog and digital formats, and stored on a variety of corresponding mediums, including traditional analog video tape, DVDs, digitized video stored on computer hard drives, pre-recorded DTV and HDTV video segments, etc. The videos may be cataloged according to the category of the product or service and the name of the third party.

Step 20 of the method includes overlaying additional information, preferably related to the products and/or services being advertised, or the channel, or other products or services offered on the channel, onto each of these segments by well known video editing techniques. The information added to each segment may, but does not necessarily, vary the length of time of the infomercial. Overlays that would change the length of the segments could include certain introductory or interstitial information that would benefit the viewer. Similarly, certain portions could be edited out in order to achieve lengths other than 28½ minutes in order to fit a customized programming schedule. Additional information may be superimposed onto the infomercial in the form of a video overlay, including stills, tickers and pop-ups. The purpose of the overlaid information is to grab the attention of the potential consumer and to create a deeper understanding of the product, the service, the advertiser, the channel or the channel's related customer service offerings.

The overlaid information preferably includes additional consumer content relevant to the products and/or services being promoted. This information is preferably the result of a separate step of conducting research by the channel on the product and/or the services, and the advertiser. These overlays may address concerns that consumers have about infomercials by including graphical information designed to provide consumers with additional confidence about a given product, service or company. The overlay information may include testing results on the particular product or service that is stored in the channel's proprietary database of product testing. The overlay information may also include verification of unpaid testimonials in the database, privacy and return policies and information on the history of the product, service, advertiser or the producer of the infomercial.

In step 30, each of the segments containing the overlays is introduced into continuous programming that is preferably sufficient to fill an entire programming day of the channel, the predominance of which will be LFDR programming. During this editing step, each of the segments is cataloged and arranged in a congruous order. The products or services in one segment will preferably have some logical relationship with the segment that immediately precedes or follows another segment. For example, the channel may have a two hour block dedicated to cars with one hour of programming being dedicated to one manufacturer, e.g., “Ford”™, with the name “The Ford Hour” being overlaid into the programming. Certain categories of products and services are sufficiently neutral that they can be interspersed at any place in the programming.

The programming is committed to a schedule in step 40 of the method, which is made available to television, video and other programming guides and services at step 50. In this preferred embodiment, a modem or high speed Internet connection is used to transmit the schedule. A predefined programming schedule allows viewers to find content that is of interest to them and allows the video infomercial programming channel, for the first time, to operate in a manner similar to traditional entertainment television networks. For example, certain segments may be shown in regular defined time slots. Further, the viewing of the segments can be made available through Video On Demand (VOD) or time shifted by the viewer using VCRs, smart set-top-boxes, local DVRs including “Tivo” branded DVRs, network DVRs, etc.

For many existing LFDR segments, show titles will need to be created since these segments are either unnamed or have names not intended for public consumption or to attract a viewing audience. Television programming guides are available over the Internet and in the print media, such as local newspapers and the national publications such as TV Guide.

The programming is distributed at step 60. The primary distribution is from a television studio to an over the air, cable or satellite feed for broadcasting over a selected television channel. In the preferred embodiment, the programming is transferred to the aforementioned outlets via high speed network connection. The programming may also be distributed over the Internet or made available to VOD services.

Current VOD offerings are primarily limited to entertainment programming, particularly movies. These current VOD offerings do not provide for a collection or cataloging of exclusive commercial programming, either short or long form, that include overlay information as described herein. Moreover, current VOD services do not allow the consumer to organize programming, such as informational or entertainment programming, and do not market such programming under one proprietary or brand name. The present invention, by contrast, adds value to the consumer experience by allowing viewers to control their commercial programming based on interest and need. The theory that such a demand exists is based in the research that, on average, the infomercial buyer will watch a commercial three times before purchasing. This demonstrates the “considered purchase” aspect of the infomercial buying process. Such a characterization of the infomercial buyer is counter to conventional wisdom, which labels the infomercial buyer as an “insomniac, surfing, and impulse purchaser.” Because of this mischaracterization of the benefits of demonstration marketing, VOD is an extension of the infomercial programming product that has not been used before.

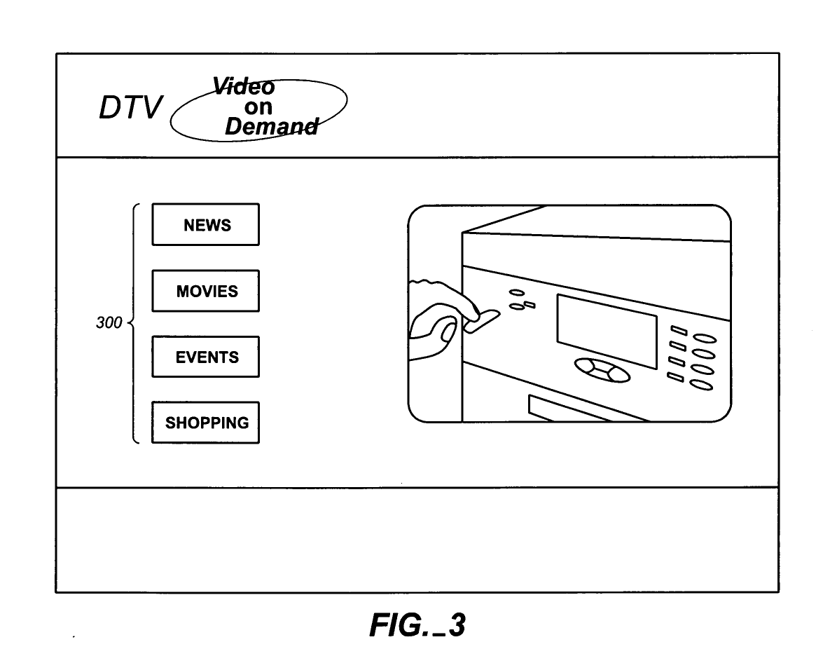

In another embodiment of the present invention, added value cataloging or “navigation” through infomercial programming is made possible by use of an interactive display to access the VOD offerings as illustrated in the navigation screen displays of FIGS. 3-11, that are described in greater detail below. The media outlet guides viewers through a shopping process to find a video selection within the programming of the present method. Current VOD fare is cataloged by title or genre, but does not attempt to guide viewers through a selection process based on needs or desires. The present invention proposes using VOD based on the way people shop, not just on the viewing of the video content. The present method provides a new type of VOD navigation such as gift categories, e.g. “for men,” “for women,” “housewarming,” and “friendship.” It also includes proprietary research categories, e.g., “top user reviews,” “best new products,” “hits from 2003,” and similar categories. The present invention further uses current technologies to provide proprietary information on the monitor screen prior to the VOD selection. Current entertainment based VOD guides do little more than provide title and synopsis information. The present invention uses the navigation screens of the VOD services to provide proprietary shopping information specific to the selection, such as “The XYZ Company has been in business for 15 years,” “5 star user rating,” and similar overlaid information.

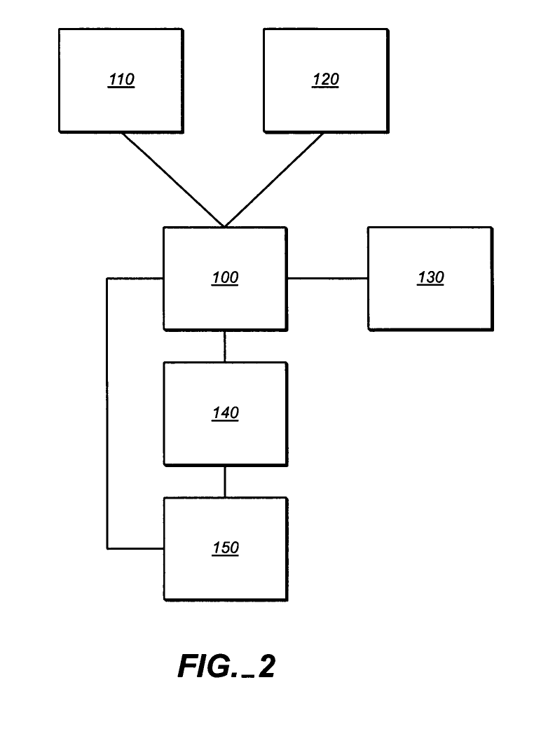

FIG. 2 shows one embodiment of the system of the present invention in which computer system 100 having a database receives digitized prerecorded infomercial or other video advertising from source 110 and source 120. Each of the infomercial segments received from a given source is for a certain length of time as set by the third party. With or without varying the length of time of the infomercial, additional information is superimposed onto the infomercial in the form of a video overlay. Digital video editor 130 is designed to add a video overlay in the form of a strip that is placed along the bottom or top of the infomercial or to add pop-ups. During the running of the infomercial, the graphical display and text created for the overlays or pop-ups will appear as text boxes or graphical images on display screens of the viewers and potential consumers. Commercially available editors can be purchased from Apple, e.g. Power Mac G5 and Mac OS X Panther with Final Cut Pro-4 software; and Avid Technology Inc., e.g. Avid Adrenaline, Avid Nitris, and Avid Mojo. For example, Avid Adrenaline allows one to transform either Mac or PC desktop and laptop computers into effective editing workstations.

An identifying or tracking label is entered into the computer system 100 for each of the resulting infomercial segments with overlays. The above process is repeated until a package of infomercial programming is sufficient to constitute a day of programming. A committed schedule for the resulting packaging is established either by a human editor that makes selections on the order of the segments or through the use of a software program that sorts the identifying labels so that the various infomercials are in a congruous order and within time slots. The programming schedule is sent directly from central computer system 100 to programming guide services 140. Similarly, the programming is distributed to various media outlets 150 and viewers in the manner described above.

Rather than just sell to the highest bidder, the programming channel of the present invention selects content based on its production quality, entertainment value, and audience appeal and/or preference. A major programming difference between the channel of the present method and traditional networks is that in the present invention the pool of video used in the programming is predominantly selected from the finite inventory offered by advertisers. Traditional networks must either create their own programming or buy it from others.

In the preferred embodiment of the present invention, LFDR blocks of programming are purposefully and systematically scheduled and promoted using a wide range of electronic programming guides available on the Internet and elsewhere. The channel of the present method collects information to test the response rate and viewer preference not just of a given timeslot, but of a series of paid infomercial programming shows or concepts in different orders and during different time slots. The results of such testing form one part of the channel's proprietary database of product testing. The proprietary database also includes the information based on the research conducted on the various products, services and advertisers of the paid programming. A portion of these types of information are included in the overlays or pop-ups.

The channel of the present invention systematically schedules and lists all the LFDR programming time slots under a proprietary name. This will allow the channel to indicate to potential viewers the kinds of paid programming that they will see in order to draw the widest possible audience for that particular type of infomercial. The promotion of upcoming paid programming time slots is done in various formats including short form commercials on other networks that identify the proprietary name selected for the channel and the specific LFDR that are to be featured. As a result, advertisers buying time will receive general advertising support by the channel of the present method in addition to the long form time slots they have purchased. Additionally, these advertisers can independently promote their upcoming time slot on this channel in other offline channels that have consistent network affiliation and without the risk of over-rides.

In contrast to current infomercials that are produced using widely varying versions, the present method creates one exclusive branded “channel version” of paid programming under one proprietary name. In contrast to opening with a text screen containing disclaimers, the paid programming segments of the present method will open with eye catching graphics or host announcers that will provide context for the infomercial including information on product category, the advertiser, or results of consumer tests. Occasionally, the paid programming will package multiple short form, separately cataloged advertising segments into one infomercial of thematically related LFDR products of a half hour or hour long broadcast blocks. This will permit advertisers to buy segments shorter than 28.5 min. These blocks are then combined with other segments to produce the day of infomercial programming.

The channel of the present invention serves both as a media distributor of infomercials and a value added service provider. While this channel is a media outlet, as opposed to a seller of products directly to consumers, the channel does offer services consistent with such retailers. The channel provides an extended guarantee/warranty, policies on privacy and customer service, and similar services, for viewers who purchase products presented on the channel. These additional services not presently offered by currently produced infomercials are intended to do nothing but create additional consumer demand and therefore attract additional advertisers wishing to have their infomercials aired by the present channel that will in turn raise the value of this channel.

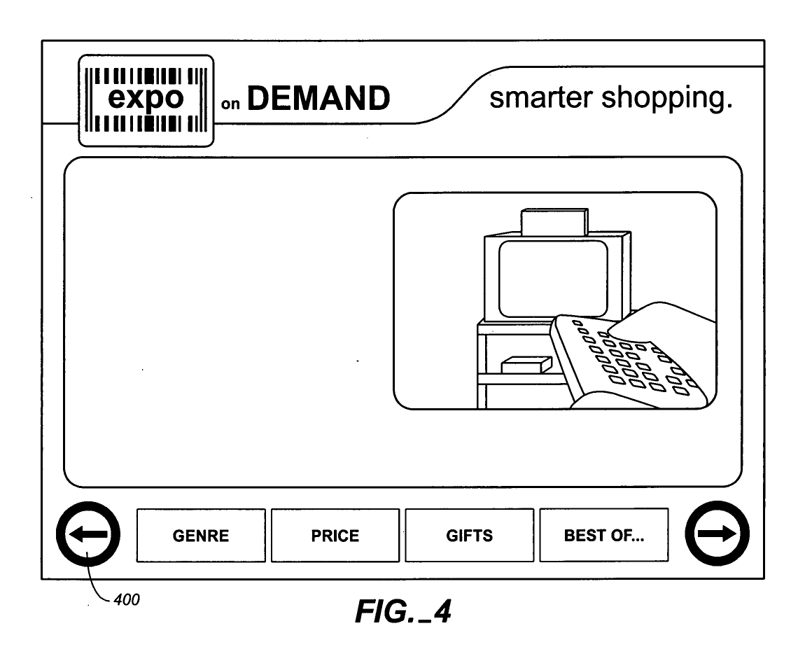

FIGS. 3-11 are screen shots in accordance with a preferred VOD embodiment of the present invention. FIG. 3 shows menu boxes on the left side of the screen including boxes for “news”, “movies”, “events” and “shopping,” identified as box 300. If a viewer clicks box 300 with a television remote control, mouse, keyboard or other input device, the screen display of FIG. 4 appears.

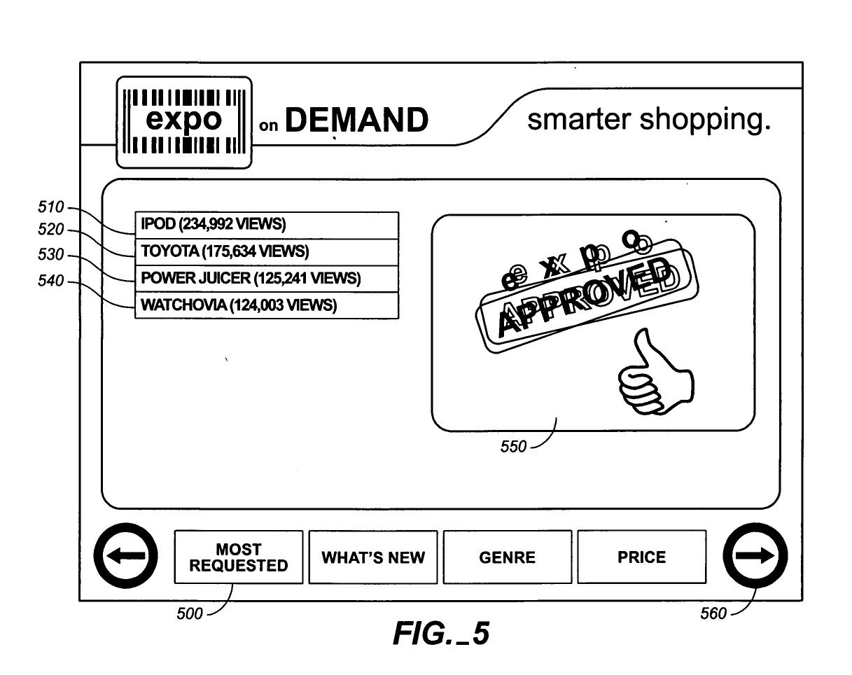

FIG. 4 shows the first proprietary screen of the preferred VOD embodiment in accordance with the present invention. If the viewer clicks bottom left arrow 400 of FIG. 4, the screen display of FIG. 5 comes into view.

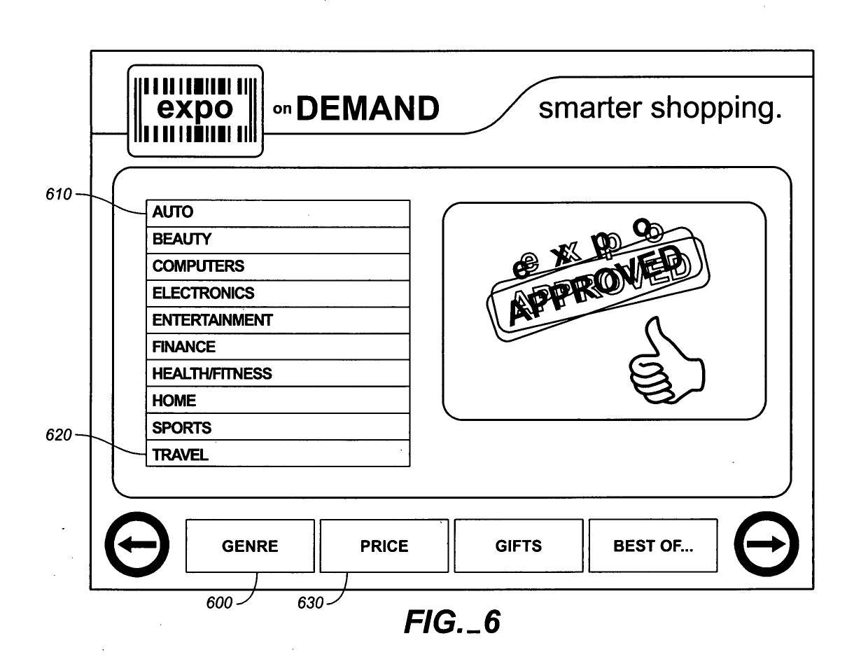

If the “Most Requested” selection box 500 appearing along the bottom of the screen of FIG. 5 is hit, the results in the menu of “Most Requested” items shown in left boxes 510, 520, 530 and 540 and right box 550 that is the embedded screen for viewing video and other content comes into view. In box 550, the default is a video feed previewing featured programming. In this illustration, a secondary graphic showing the channel's endorsement of the available offerings is shown. After bottom right arrow 560 in FIG. 5 is hit, the screen display of FIG. 6 become visible.

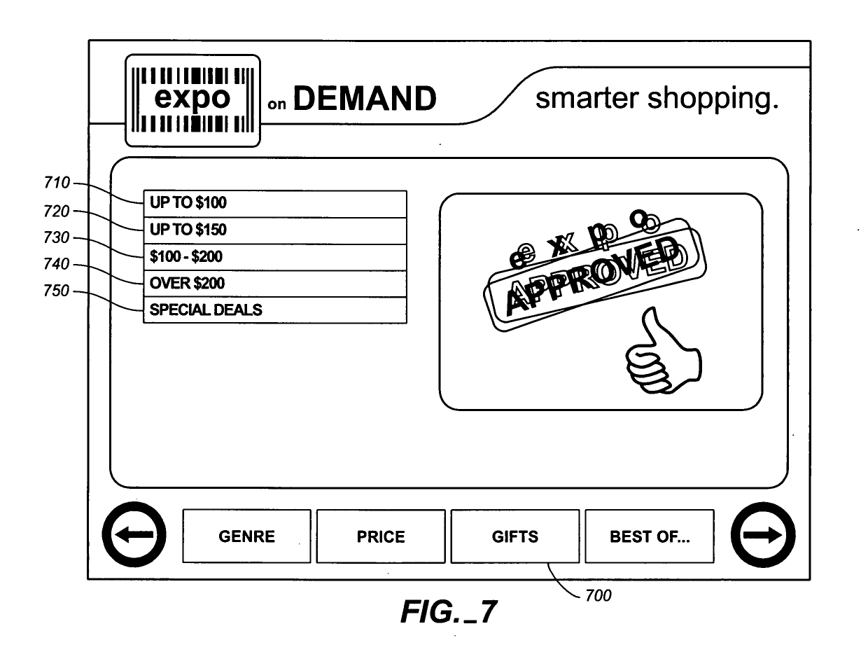

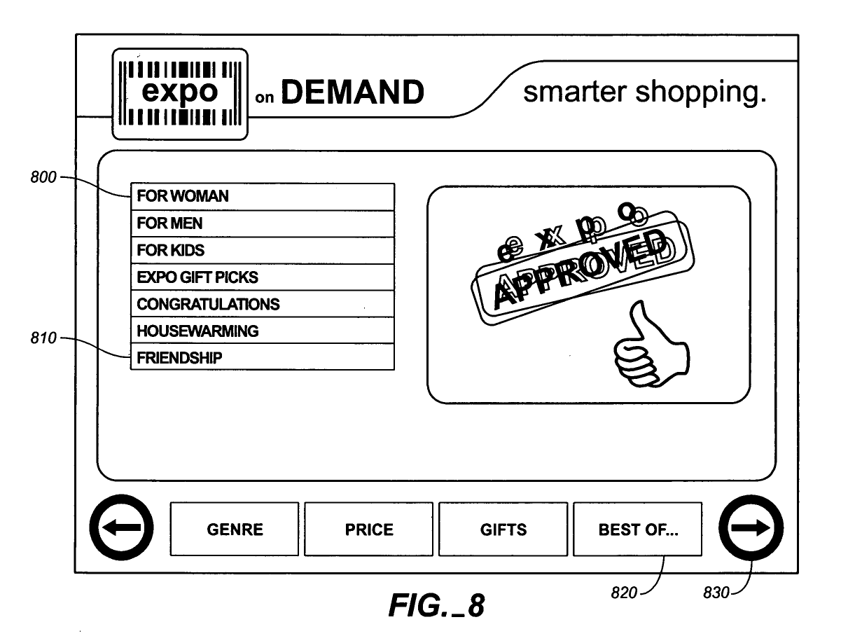

If the viewer hits “Genre” box 600 of the screen display of FIG. 6, the menu boxes show various selection choices of the categories ranging from “Auto” box 610 to “Travel” box 620. If “Price” box 630 is hit, the screen display of FIG. 7 is visible. The price categories of “up to $100,” “up to $150,” “$100-$200,” over $200,” and “special deals,” are visible in the respective left boxes 710, 720, 730, 740, and 750. When a user hits “Gifts” box 700, the screen display if FIG. 8 comes into view.

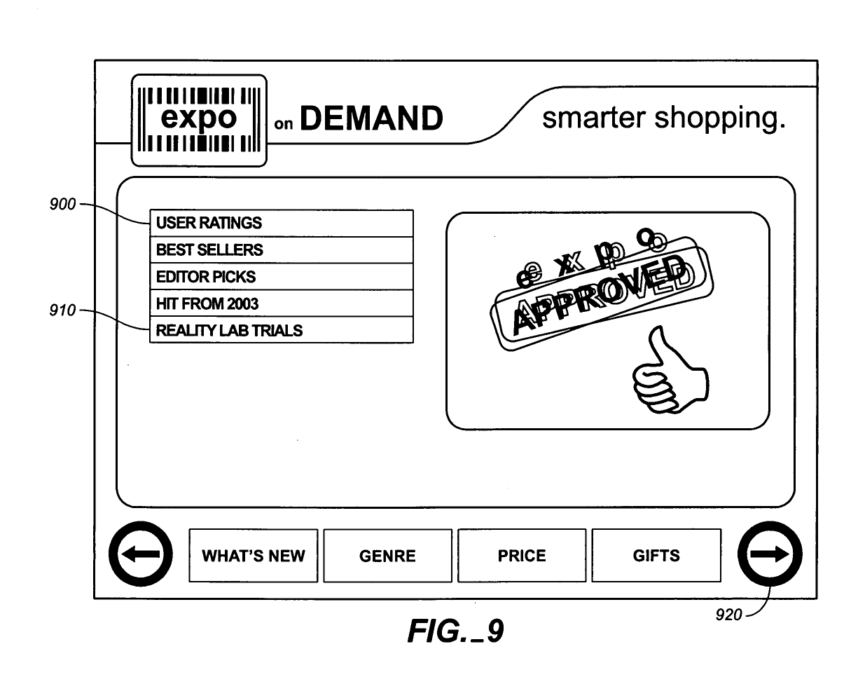

In the screen display of FIG. 8, the gift menu ranges from gifts “For Women” down to gifts for “Friendship” in box 810. Upon hitting “Best of” box 820, the screen display of FIG. 9 appears. Right arrow 830 is hit twice to get the same categories of selection boxes that appear in the screen display of FIG. 9. Each screen was designed to have only four boxes visible at the bottom. The other bottom boxes are word wrapped and are visible by clicking either the right or left arrow on each screen.

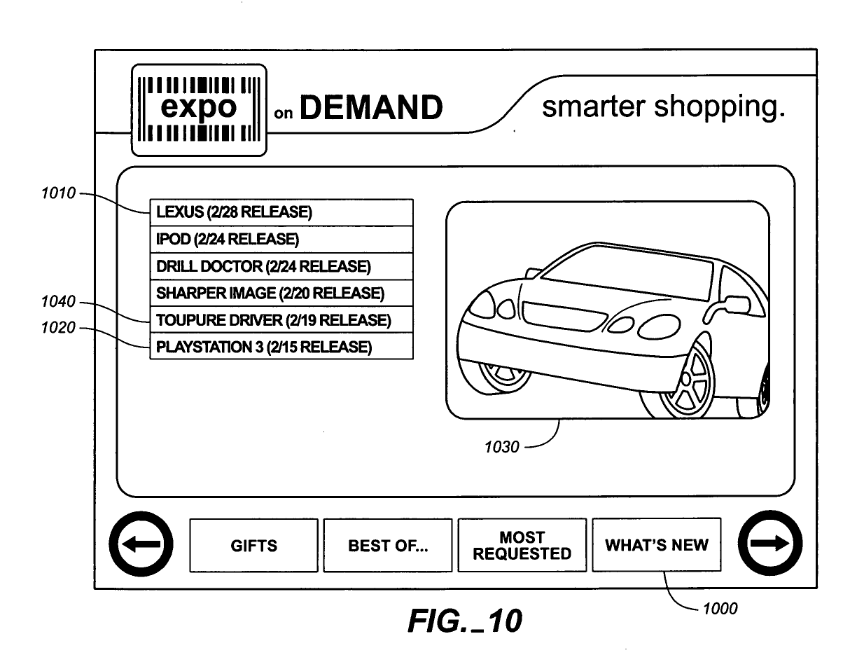

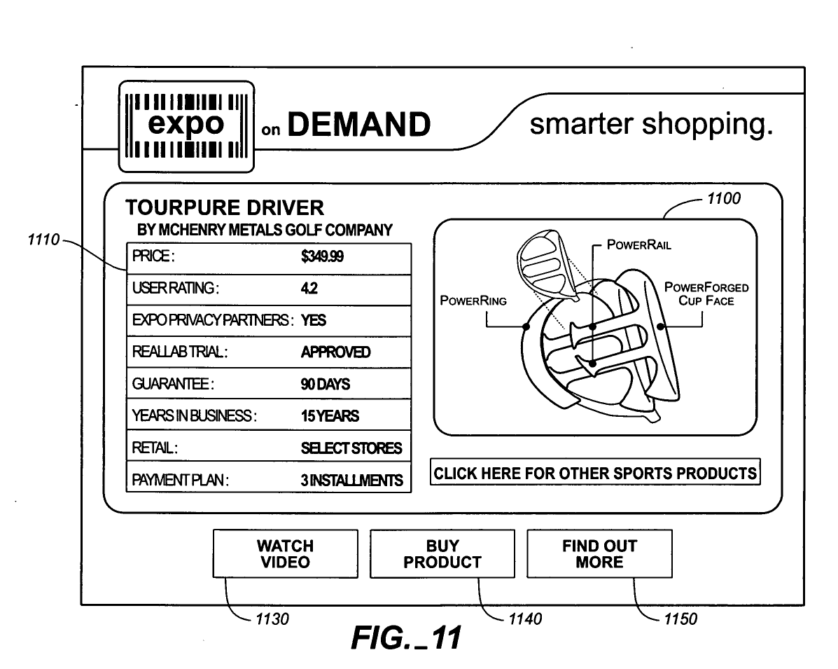

FIG. 9 is the screen display of the menu for “Best of” box 820 and includes items of the menu that range from “User Rating” in box 900 to “Realty Lab Trials” in box 910. Bottom right arrow 920 is hit twice to take the user to the screen display of FIG. 10. If the “What's New” box 1000 is hit, a menu of the latest products and the dates they were released and became available appears. In this example, the latest products range from “Lexus (2/28 release)” in box 1010 to “Playstation 3 (2/15 release)” in box 1020. FIG. 10 show video screen showing a photo of the Lexus of box 1030 that appears if the user simply rests the cursor of the mouse or other device on box 1010. If, for example the “Tourpure Drive (2/19 release)” box 1040 were hit with the cursor, the FIG. 11 screen appears.

In FIG. 11, video window 1100 appears in the screen display along with a list of performance and other sales information relating to the product in the left boxes 1110. By clicking on the “Watch Video” box 1130, an infomercial segment video on that particular product is shown in window 1100. By clicking “Buy Product” box 1140, the user becomes the buyer after the usual credit card information and personal information of the buyer are inputted. Finally if “Find Out More” box 1150 is hit, additional information is displayed or the information will be sent to the user.

The above description is intended to merely exemplify one embodiment of the use of VOD in connection with the present invention. As described above, each text box of the VOD embodiment has a meta tag that moves the viewer to the next level of the VOD infomercial. The viewer has full interactive control of just the products of interest.

Various modifications of the method and system of the present invention in addition to those shown and described above will become apparent to those skilled in the art from the foregoing description and accompanying drawings. Such modifications are intended to fall within the scope of the appended claims.

1. A method of providing a video infomercial programming channel comprising the steps of:
(a) collecting prerecorded video advertising segments from third parties;
(b) overlaying additional information onto the video advertising segments;
(c) introducing the resulting video advertising from step (b) into infomercial programming to substantially fill a programming day;
(d) committing the programming to a schedule;
(e) providing the programming schedule to a programming guide service to include entries of the schedule into the guide for consumers; and
(f) distributing the programming to media outlets.

2. The method of claim 1, wherein the programming is sufficient to substantially fill a 24 hour day of programming.

3. The method of claim 1, wherein the video is long form.

4. The method of claim 1, wherein the programming is distributed via television, broadcast, Internet, or by video-on-demand.

5. The method of claim 1, wherein the entries in the media programming guide are listed in congruous order.

6. The method of claim 1, wherein the programming segments are loaded onto servers for video-on-demand.

7. The method of claim 6, wherein related archived prerecorded video advertising segments are also loaded onto the servers.

8. The method of claim 7, wherein after step (a) an additional step is to conduct research on the product or services or the advertiser.

9. The method of claim 1, wherein the programming guides are in electronic form.

10. The method of claim 1, wherein the programming channel is promoted on other channels.

11. The method of claim 1, wherein the additional information being overlaid is directly related to the product or services being advertised.

12. The method of claim 1, wherein a series of prerecorded video advertising segments directed to a plurality of products, services or products and services that are thematically related are combined and distributed within a given time block of the schedule for the programming channel.

13. The method of claim 12, wherein the time block ranges from about 30 to about 120 minutes.

14. The method of claim 1, wherein the perspective consumer is provided with a privacy guaranty.

15. The method of claim 1, wherein a potential consumer orders the products or services directly from or through the programming channel.

16. The method of claim 1, wherein additional information appears as a strip of textual information overlaid across the video advertising.

17. The method of claim 1, wherein additional information appears as a pop-up of textual information overlaid onto the video advertising.

18. The method of claim 15, wherein demographic information on the potential consumer is collected and sent to the programming channel.

19. The method of claim 18, wherein the distribution is via video-on-demand.

20. A method of providing a video infomercial programming channel comprising the steps of:
(a) collecting prerecorded video advertising segments of products and/or services from third parties;
(b) conducting research on the products and/or services;
(c) overlaying additional information onto the video advertising segments;
(d) introducing the resulting video advertising from step (c) into infomercial programming to substantially fill an entire day of the programming channel;
(e) committing the programming to a schedule;
(f) providing the programming schedule to a programming guide service to include entries of the schedule into a programming guide for consumers specifically indicating the product or types of products to be broadcast over the channel; and
(g) distributing the programming to viewer through an interactive service.

21. The method of claim 20, wherein additional information that is overlaid onto the video advertising segments is related to the product and/or services.

22. The method of claim 20, wherein the additional information is related to the advertiser.

23. The method of claim 20, wherein additional information is related to the research conducted in step (b).

24. A method of providing a video infomercial programming channel comprising the steps of:
(a) collecting prerecorded video advertising from third parties;
(b) overlaying additional information onto the video advertising;
(c) introducing the resulting video advertising from step (b) into infomercial programming to substantially fill an entire day of the programming channel;
(d) committing the programming to a schedule; and
(e) distributing the programming.

25. The method of claim 24, wherein the additional information is related to the product and/or services.

26. The method of claim 24, wherein the additional information is related to the advertiser.

27. The method of claim 24, wherein the additional information is based on research conducted on the product, services or the advertiser.

28. A system for providing a video infomercial programming channel comprising:
(a) a central computer system for receiving and storing a plurality of digitalized prerecorded video advertising segments from third parties;
(b) a video editing device for superimposing additional information specifically related to the product or services described in the segments;
(c) an assembler for identifying and cataloging each of the resulting video advertising segments, assembling each of the segments into infomercial programming in a fixed temporal schedule to substantially fill a programming day, and storing the identification information and programming schedule; and
(d) a communication system for transmitting the identification information and programming schedule to a programming guide service for including entries of the schedule into a guide for consumers and for distributing the programming to media outlets selected from the group consisting of television, video-on-demand, Internet, and set-top box.

29. A system for providing a video infomercial programming channel via video-on-demand comprising;
(a) a central computer system for receiving a plurality of digitalized prerecorded video advertising segments from third parties and storing in a database;
(b) a video editing device for superimposing additional information specifically related to the product or services into information presented before the segment or directly onto each of the video advertising segments of the programming;
(c) an assembler for identifying and cataloging each of the resulting video advertising segments; and
(d) a communication system for distributing the programming to the Internet or digital television using a video-on-demand format for interactivity with a potential consumer.

30. A system for providing a video infomercial programming channel via video-on-demand comprising;
(a) a central computer system for receiving a plurality of digitalized prerecorded video advertising segments from third parties and storing in a database;
(b) a video editing device for superimposing additional information specifically related to the product or services into information presented before the segment or directly onto each of the video advertising segments of the programming;
(c) an assembler for identifying and cataloging each of the resulting video advertising segments;
(d) a communication system for distributing the programming to the Internet or digital television using a video-on-demand format for interactivity with a potential consumer; and
(e) a device to allow a potential consumer to browse the infomercial programming via a plurality of pathways.

31. The system of claim 30, wherein said device allows potential consumer to browse the infomercial programming via a plurality of VOD navigation screens.

32. The system of claim 31, wherein the superimposed information includes verification of privacy, return policies, guaranty/warranty, and information on the history of the product or services.

33. A method of providing a video infomercial programming channel comprising the steps of:
(a) collecting prerecorded video advertising segments from third parties;
(b) overlaying additional information onto the video advertising segments;
(c) introducing the resulting video advertising from step (b) into infomercial programming to substantially fill a programming day; and
(d) distributing the programming.
